(19) United States
(12) Patent Application Publication
(10) Pub. No.: US 2025/0376219 A1
(43) Pub. Date: Dec. 11, 2025

(54) Closing Aid for a Vehicle Trunk

(71) Applicant: Illinois Tool Works Inc., Glenview, IL (US)

(72) Inventors: Stefan Jatzke, Bockenheim an der Weinstraße (DE); Andreas Senn, Neuhemsbach (DE)

(21) Appl. No.: 19/221,194

(22) Filed: May 28, 2025

(30) Foreign Application Priority Data
Jun. 10, 2024 (DE) 10 2024 116 105.1

(51) Int. Cl. B62D 25/12; B60J 10/80; B60R 5/02; B60R 21/00; B60R 21/34; B62D 25/08; F16K 17/04

(52) U.S. Cl. CPC B62D 25/12; B60J 10/80; B60R 5/02; B62D 25/087; F16K 17/0413; B60R 2021/0004; B60R 21/34; B60R 2021/343

(57) ABSTRACT

The disclosure relates to a closing aid for a luggage compartment (2) located at the front of a vehicle (1). The compartment can be sealed—at least partly or almost completely—from the outside air. The closing aid includes a valve system (10) that activates if there's a sudden increase in pressure inside the closed luggage compartment. When activated, the valve allows pressure to be released from the sealed compartment to the outside air.

### RELATED APPLICATION

The present application claims the benefit of German Patent Application No. 10 2024 116 105.1, filed Jun. 10, 2024, titled “Closing Aid for a Vehicle Trunk,” the contents of which are hereby incorporated by reference.

### BACKGROUND

Closing aids for motor vehicles are in particular used for comfort and safety. For example, German publication DE 10 2013 216 328 A1 discloses a vehicle door lock that has a pulling aid or a closing aid. A further vehicle door lock having a corresponding closing device is known from publication DE 10 2013 102 814 A1.

Such vehicle door locks are installed inside doors of a vehicle, in rear doors, and also in rear flaps. An electrical closing drive serves to perform a motorized procedure or to support a final closing operation for a locking element of the vehicle door lock. A flap of the vehicle is brought from a pre-closing position to a locked main closed position against the force of seals or springs or friction or other counteracting forces. The user thus places the flap, for example the side door or the tailgate, in the pre-closing position, wherein the various locking elements of the lock (for example the rotary trap and the closing bracket) are engaged with one another at engagement distance. The catch is then moved by the motor drive such that it engages with the striker and pulls the flap to a locked position. This process is described in the aforementioned publications.

In some designs, the movement during the closing of the door or flap is driven by a motor, but the return after successful closing is carried out by a spring element. For example, if the drive acts on the closing elements of the lock via a Bowden cable, the drive is switched off after locking and catching of the closing operation, and the Bowden cable is retracted to its initial position by a spring bias. If a coupling is not provided, the electric motor is also driven, because it is rotationally coupled to the resetting elements in a rotationally fixed manner by a chain of action. The motor is thus driven externally and functions as a generator.

The closing aids described above are suitable for vehicle doors or rear flaps equipped with a corresponding vehicle door lock. This is usually not provided for a front luggage compartment (also known as a “frunk”), i.e., an additional storage space in the front region, in particular of an electric vehicle. In this respect, the solutions known from the prior art cannot be used in such stowage spaces in the front region, in particular of an electric vehicle.

In addition, the conventional closing aids have a rather complex construction, and in particular require at least one electromotive actuator, which must be controlled accordingly. In addition to a weight increase associated with this, the construction space necessary for the assembly of the electromotive actuator is to be mentioned as a further disadvantage.

### SUMMARY

The present disclosure relates generally to a valve for a closing aid, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1 illustrates schematically and in an isometric view, a vehicle having a luggage compartment configured in the front region of the vehicle and an exemplary embodiment of the closing aid according to the disclosure.

FIG. 2 illustrates schematically and in an exploded view, a first exemplary embodiment of a valve for the closing aid according to the disclosure.

FIG. 3 illustrates schematically, and in an isometric view, the exemplary embodiment of the valve according to FIG. 2.

FIG. 4A illustrates schematically, and in a sectional view, the exemplary embodiment of the valve according to FIG. 2 in an opened state.

FIG. 4B illustrates schematically, and in a sectional view, the exemplary embodiment of the valve according to FIG. 2 in a closed state.

FIG. 5A illustrates schematically, and in an isometric view, a second exemplary embodiment of a valve for the closing aid according to the disclosure.

FIG. 5B illustrates schematically, and in a sectional view, the second exemplary embodiment of the valve according to FIG. 5A in an installed and closed state.

FIG. 5C illustrates schematically, an excerpt from FIG. 5B.

FIG. 6 illustrates schematically, and in an isometric view, a further exemplary embodiment of the valve for the closing aid according to the disclosure.

FIG. 7 illustrates schematically, and in an isometric view, a further exemplary embodiment of the valve for the closing aid according to the disclosure.

FIG. 8 illustrates schematically, and in an isometric view, a further exemplary embodiment of the valve for the closing aid according to the disclosure.

FIG. 9A illustrates schematically, a further exemplary embodiment of a valve for the closing aid according to the disclosure, having a mechanical touch protection.

FIG. 9B illustrates schematically, and in an isometric exploded view, the exemplary embodiment of the valve according to FIG. 9A.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein is not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent to or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y, and/or z” means “one or more of x, y, and z.”

The present disclosure relates to a closing aid for the luggage compartment of a vehicle.

In particular, the disclosure relates to a closing aid for a vehicle, which comprises a luggage compartment configured in the front region of the vehicle, which can be closed with the aid of a luggage compartment cover, in particular in the form of a luggage compartment flap.

Because the space requirement for the drive train in electric cars is often smaller compared to the space requirement for the drive train in vehicle types having a front drive, electric cars are often provided with a luggage compartment in the front region in addition to the luggage compartment in the rear, in which, for example, the charging equipment can be accommodated. This space is also sometimes referred to as a “frunk,” which is a combination of front and trunk.

The closing aid of the type according to the disclosure is in particular part of such a luggage compartment configured in the front region of a vehicle.

Accordingly, the problem addressed by the disclosure is to specify a closing aid for a luggage compartment in the front region of a vehicle, which can be flexible and easily integrated into luggage compartment systems of different vehicles with very little space required.

Accordingly, the disclosure relates in particular to a closing aid for a luggage compartment of a vehicle that is configured in the front region of the vehicle and can be hermetically sealed in particular at least partially against the external atmosphere or at least substantially against the external atmosphere with the help of a luggage compartment cover, in particular in the form of a luggage compartment flap, when the luggage compartment cover is in its closed position.

According to the disclosure, it is provided in particular that the closing aid comprises a valve assembly, which is configured to become activated, in particular in the case of a sudden or abrupt increase in pressure in the volume defined by the luggage compartment and the luggage compartment cover in the closed position thereof, and to enable a pressure relief between the volume defined by the luggage compartment and the luggage compartment cover in the closed position thereof and the external atmosphere.

The advantages achievable with the closing aid according to the disclosure are clear: by providing the valve assembly, a positive pressure in the luggage compartment is removed as quickly as possible when closing the luggage compartment with the help of the luggage compartment cover. The valve assembly is in particular designed so that when closing the luggage compartment cover, the overpressure that builds up in the luggage compartment in the luggage compartment is equalized in a short time in order to significantly simplify the closing process of the luggage compartment cover. For closing aids with an electric motor actuator, the electric motor actuator without a valve assembly would need to provide a corresponding amount of power for closing the luggage compartment cover.

In frunk applications in particular, the closing aid according to the disclosure is of particular importance. Because the luggage compartment is typically hermetically encapsulated with respect to the vehicle interior, correspondingly occurring pressure build-up in the luggage compartment cannot be equalized by a gas exchange with the vehicle cabin when closing the luggage compartment.

With the closing aid according to the disclosure, pedestrian protection is additionally provided. This is another (additional) benefit. Increasingly, in the front region of a vehicle, pedestrian protection assemblies are increasingly provided.

Pedestrian protection assemblies for vehicles are known in numerous variations. Pedestrian protection requirements are increasing. Requirements for design, lightweight construction, and/or cW value are often contrary to this.

For pedestrian protection, between bumpers and other components behind the bumper, so-called “pedestrian protection foams” are often used. These foams typically have a relatively high uniform hardness, but this may not be optimal for pedestrian protection.

It is also known to provide a type of “airbag system” in the front region of a vehicle as a pedestrian protection assembly.

Finally, triggerable hood systems are known as a pedestrian protection system. The bumper of the vehicle contains energy-absorbing material in its construction, as well as sensors that detect the impact of a pedestrian and activate a triggerable hood system. In the case of a crash, the hood hinges are released by the system so that the rear edge of the luggage compartment cover or hood can lift so that a distance between the hood and the components in the engine compartment is increased. However, this triggerable hood system is relatively expensive to install and is primarily suitable for pedestrian protection assemblies in front-engine vehicle types.

The closing aid according to the disclosure provides the further advantage of allowing pedestrian protection for vehicles with a luggage compartment in the front region at least to a certain extent, which can be flexibly and easily integrated into luggage compartment systems of different vehicles with very little space requirement.

By providing a valve assembly that responds in particular to a sudden or abrupt increase in pressure and allows for a pressure relief between the luggage compartment volume and the outer atmosphere, it is additionally achieved that the rigidity of the luggage compartment cover is reduced, and the luggage compartment cover can in particular deform plastically or elastically and thus represents a compliant structure. In case of an accident, for example with a pedestrian, the then relatively “soft” luggage compartment cover constitutes a type of “crumple zone,” so that at least serious injuries, in particular serious head and neck injuries, are reduced for the pedestrian involved in the accident. In other words, the disclosure also reduces the risk of injury when the vehicle collides with a pedestrian.

The disclosure thus allows for a simplified closing of the luggage compartment cover on the one hand. On the other hand, the disclosure allows the implementation of an integral pedestrian impact protection in the luggage compartment system without the need for costly structural measures. If a pedestrian impacts the luggage compartment cover with their head, for example, an increase in pressure occurs in the luggage compartment volume, as a result of which the valve assembly responds, and pressure relief is allowed. As a result, the luggage compartment cover can deform more sharply, particularly in the region of the impact site, compared to a case when no pressure relief occurs. The plastic and/or elastic deformation of the material of the luggage compartment flap results in some “energy consumption.” In other words, by providing the valve assembly, the collision energy absorption capability of the luggage compartment cover is increased.

According to implementations of the closing aid according to the disclosure, the valve assembly is configured to become activated in the event of a pressure increase resulting in particular from a deformation of the luggage compartment cover and to enable a pressure relief between the volume defined by the luggage compartment and the luggage compartment cover in the closed position thereof and the external atmosphere.

Preferably, it is provided that a critical differential pressure value between the volume defined by the luggage compartment and the luggage compartment cover in the closed position thereof and the external atmosphere, at which the valve assembly becomes activated, is in particular predefined or definable. In particular, the critical differential pressure value is selected as a function of the free air volume in the volume defined by the luggage compartment and the luggage compartment cover in its closed position.

As such, the collision energy absorption capability of the luggage compartment cover is adaptable to the respective applications.

According to design variants of the closing aid according to the disclosure, it is provided that, in its open position, the luggage compartment cover has a first rigidity value or a first collision energy absorption capacity and, in its closed position, has a second rigidity value or a second collision energy absorption capacity.

Due to an air volume in particular at least substantially hermetically enclosed by the luggage compartment and the luggage compartment cover in the closed position thereof, the second rigidity value or the second collision energy absorption capacity is in particular greater than the first rigidity value or the first collision energy absorption capacity.

In particular, the valve assembly is configured such that, upon an activation of the valve assembly, due to the pressure relief caused thereby, the rigidity or collision energy absorption capacity of the luggage compartment cover in its closed position decreases and preferably takes on the first rigidity value or the first collision energy absorption capacity or at least takes on a rigidity value or a collision energy absorption capacity lying between the first and second rigidity values or between the first and second collision energy absorption capacities.

In particular, the valve assembly serves as a type of “structure weakening device,” because the valve assembly is configured to weaken the structure and/or rigidity of the luggage compartment cover upon its activation.

According to implementations of the valve assembly used in the closing aid according to the disclosure, it is provided that the valve assembly comprises at least one valve, which is itself received and/or fixed in a receptacle opening in a wall delimiting the luggage compartment and/or in the luggage compartment cover.

The at least one valve is configured in particular such that it opens upon a predefined or definable differential pressure between the volume defined by the luggage compartment and the luggage compartment cover in the closed position thereof and the external atmosphere

In this context, it is particularly conceivable that the at least one valve of the valve assembly comprises at least one check valve as an obturator.

Alternatively, or additionally, the at least one valve of the valve assembly can be configured as a poppet check valve or ball check valve.

It is equally conceivable in principle that the at least one valve of the valve assembly is a weight-loaded, spring-loaded, in particular rotary spring-loaded, and/or gravity-loaded valve.

An activation behavior of the at least one valve of the valve assembly is in particular variably adjustable. The adjustability of the activation behavior of the at least one valve of the valve assembly preferably depends on an air volume that is in particular at least substantially hermetically enclosed by the luggage compartment and the luggage compartment cover in the closed position thereof.

According to implementations of the closing aid according to the disclosure, it is provided that the at least one valve of the valve assembly is configured as a proportional valve, whose opening behavior moves in the range of an activation differential pressure up to full opening proportionately or at least substantially proportionately to the differential pressure between the luggage compartment volume and the external atmosphere.

Alternatively, however, it is also conceivable that the at least one valve of the valve assembly is preferably configured as a full-stroke valve, which opens suddenly and preferably with a full stroke upon activation.

Preferably, the valve assembly comprises a plurality of valves, each of which is received and/or fixed in a receptacle opening in a wall delimiting the luggage compartment and/or in the luggage compartment cover.

According to implementations of the closing aid according to the disclosure, it is provided that the at least one valve of the valve assembly comprises a cage structure, in which a valve seat of the valve and a closing part of the valve, in particular a valve plate, that is movable relative to the valve seat is at least partially or regionally received.

With such a cage structure, the parts moving relative to one another, and in particular the functional mechanics of the valve, are protected. In particular, this variant is suitable in embodiments in which the at least one valve is arranged/installed in the luggage compartment trough and thus must be protected from, for example, slipping load.

The disclosure further relates to a vehicle comprising a luggage compartment that is configured in the front region of the vehicle and can be hermetically sealed in particular at least partially against the external atmosphere or at least substantially against the external atmosphere with the help of a luggage compartment cover, in particular in the form of a luggage compartment flap, when the luggage compartment cover is in its closed position. In particular, it is provided that the vehicle comprises a closing aid of the previously described type.

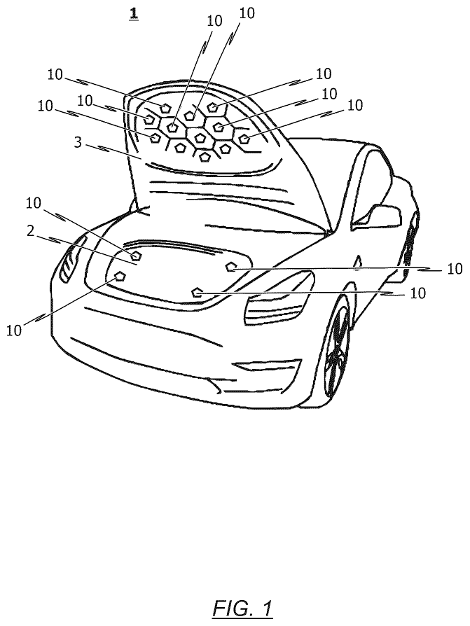

The present disclosure relates in particular to a closing aid for a vehicle 1, comprising a luggage compartment 2 that is configured in the front region of the vehicle 1 and, as indicated schematically in FIG. 1, can be hermetically sealed in particular at least partially against the external atmosphere with the help of a luggage compartment cover 3, in particular with the aid of a luggage compartment flap, when the luggage compartment cover (3) is in its closed position. FIG. 1 schematically shows the vehicle 1 in a state in which the luggage compartment cover 3 is in its open position.

The closing aid comprises a valve assembly 10, which is configured to become activated, in the case of a sudden or abrupt increase in pressure in the volume defined by the luggage compartment 2 and the luggage compartment cover 3 in the closed position thereof, and to enable a pressure relief between the volume defined by the luggage compartment 2 and the luggage compartment cover 3 in the closed position thereof and the external atmosphere.

The valve assembly 10 of the closing aid comprises at least one valve, which is itself received and/or fixed in a receptacle opening in a wall delimiting the luggage compartment 2 and/or in the luggage compartment cover 3. In FIG. 1, it is indicated merely by way of example that the at least one valve of the valve assembly 10 is itself received in the luggage compartment cover 3.

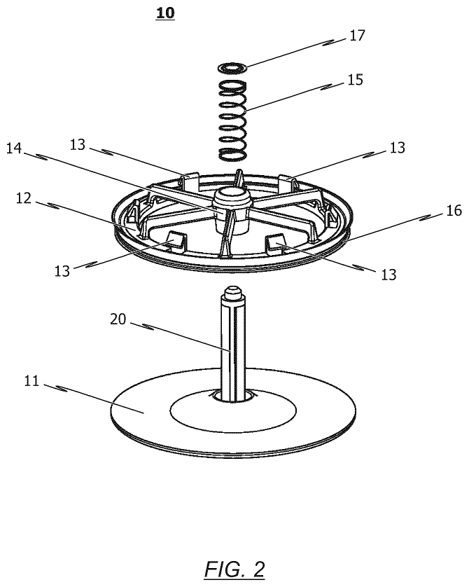

Exemplary embodiments of a valve 10 for the closing aid according to the disclosure are described below with reference to the illustrations in FIG. 2 to FIG. 8. The valves 10 shown there are in particular pressure relief valves.

The exemplary embodiments of the pressure relief valves 10 shown in FIG. 2 to FIG. 8 are configured as poppet check valves, wherein a spring 15 provides for the blocking of the valve 10. The sealing body is in the form of a level, in particular circular, plate or poppet (valve plate 11), wherein, of course, other designs for the valve plate are conceivable. A bolt or pin 20 is used for guiding.

Specifically, and as can be seen in particular from the exploded view in FIG. 2, the bolt or pin 20 is connected centrally to the valve plate 11 and stands at 90° to the longitudinal extension of the valve plate 11.

In the assembled state of the pressure relief valve 10, the bolt or pin 20 passes through a sleeve-shaped element 14 of the valve frame 12 and then receives the compression spring or spiral spring 15. At the upper end region of the bolt 20, a thickening or fixation is provided to prevent the spring 15 received by the bolt 20 from being removed.

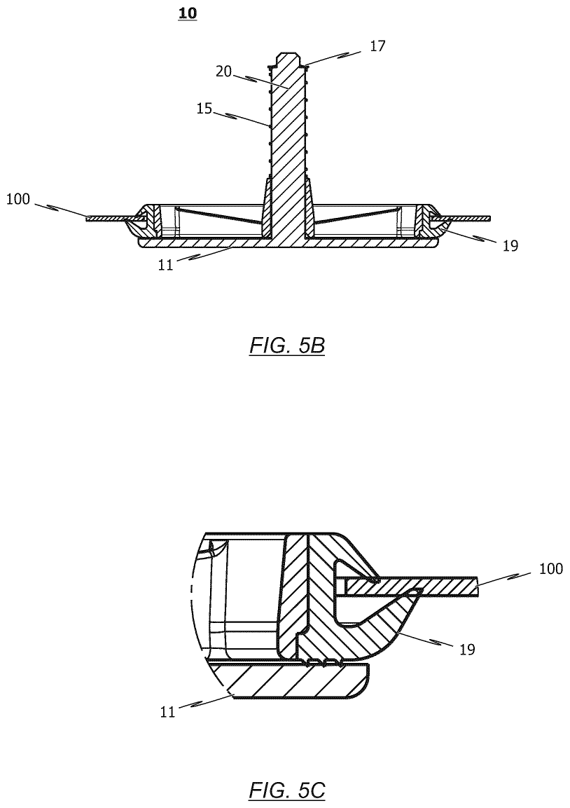

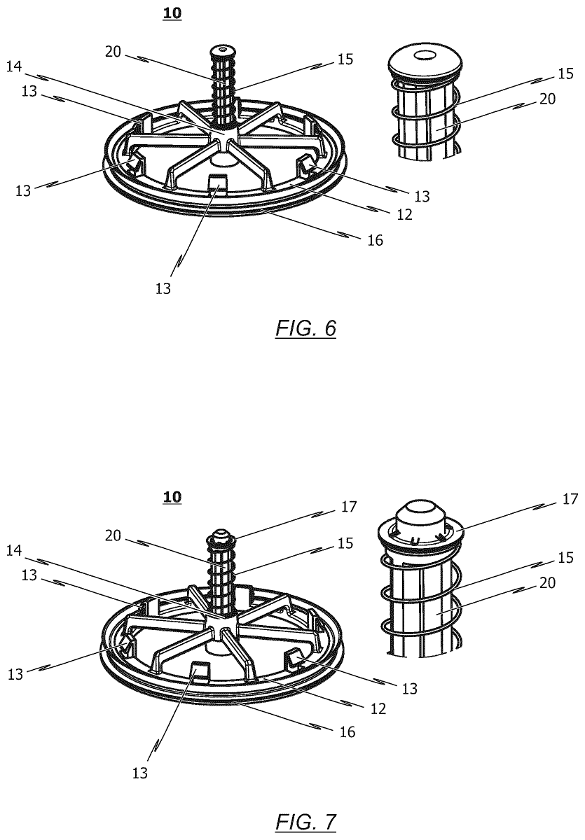

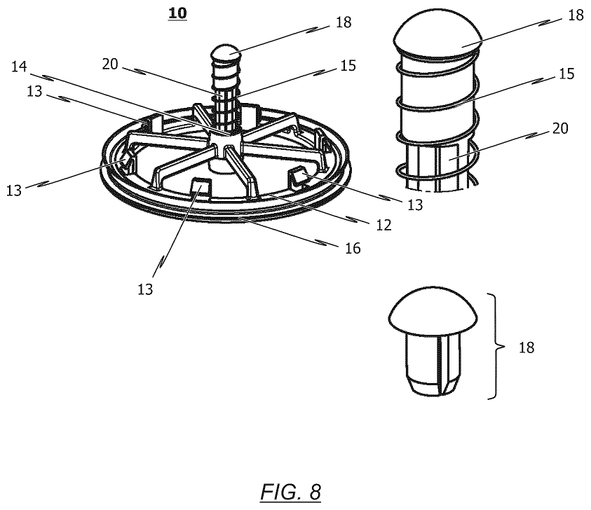

For this purpose—as shown in FIG. 6, FIG. 7, and FIG. 8—various solutions can be considered. In the exemplary embodiment shown in FIG. 6, at the upper end region of the bolt 20, a protrusion is integrally connected to the bolt 20, for example, by adhesive bonding or welding.

According to the embodiment shown in FIG. 7, a clamping ring 17 can also be used for fixation.

According to the illustration in FIG. 8, a countersunk grooved pin 18 or the like can also be used. A retracting catching function for holding the spiral spring by means of an anchor foot is also conceivable.

The valve frame 12 has catching elements 13 distributed over its outer periphery in the form of catching tabs that serve to fix the valve frame 12 to an opening of a vehicle body component 100.

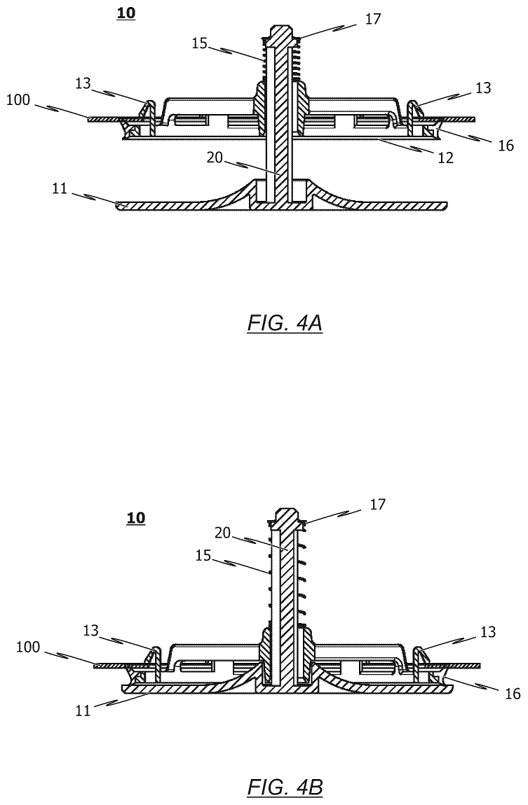

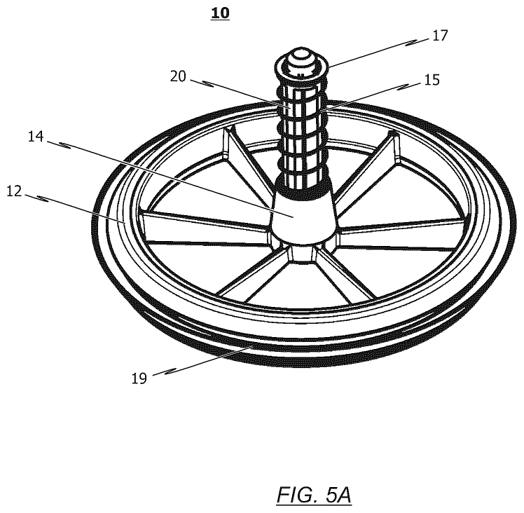

Specifically, and as can be seen in particular from the sectional views in FIG. 4A and FIG. 5B, the catching elements 13 pass through the opening of the body component 100 and thus abut the periphery of the opening in the vehicle body component 100.

The valve frame 12 further includes a seal 16 surrounding the valve frame 12, which circumferentially seals the opening in the vehicle body component in the assembled state of the pressure relief valve 10, and in particular serves to seal the valve plate 11 when closed.

The valve frame 12 is preferably injection-molded from a plastic material. The seal 16 is also made of a plastic material and can be formed together with the valve frame 12 in a 2K injection molding process.

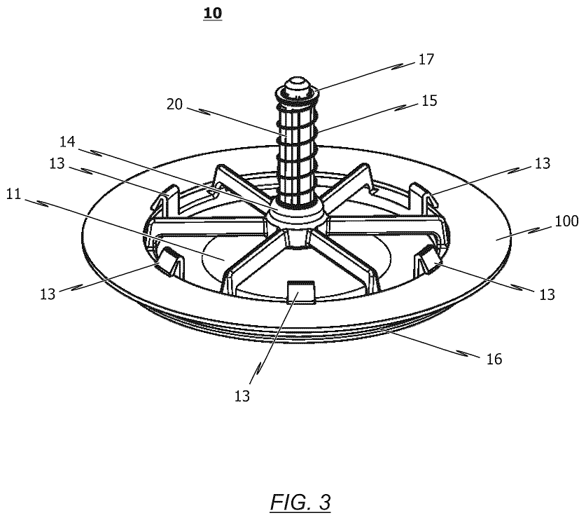

In FIGS. 5A to 5C, a variant of the pressure relief valve 10 is shown. This embodiment differs in particular from the embodiment shown in FIG. 2, FIG. 3, and FIG. 4A to FIG. 4B with respect to the seal 16 surrounding the valve frame 12.

Specifically, a double-lip seal 19 formed in a 2K injection molding process, preferably in conjunction with the valve frame 12, is used, between which the peripheral region of the receiving opening of the vehicle body component 100 is received. The double-lip seal 19 is thus used in order to fix the pressure relief valve 10 and to provide a sealing effect.

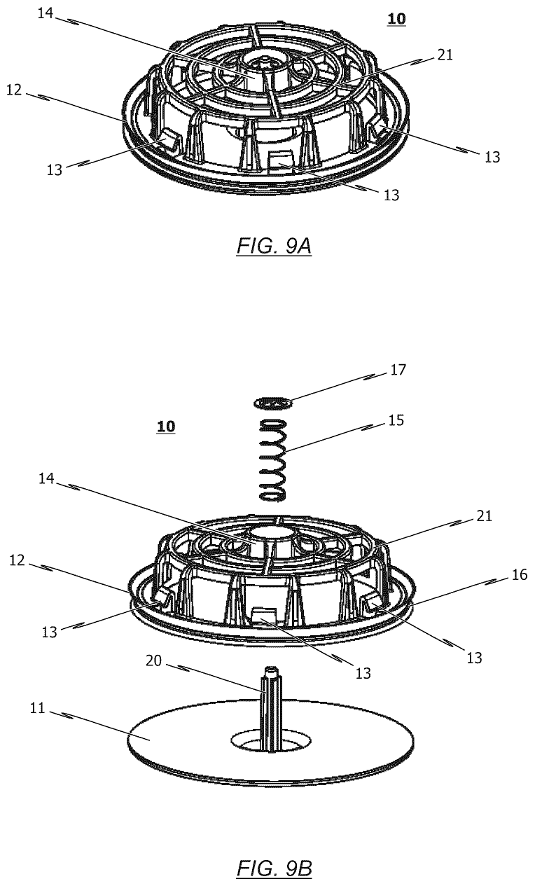

In FIG. 9A and FIG. 9B, a further exemplary embodiment of a valve for the closing aid according to the disclosure is shown. In structural and functional terms, the further embodiment of the valve corresponds to the first exemplary embodiment of the valve according to FIG. 2 and FIG. 3. However, in the exemplary embodiment of the valve according to FIG. 9A and FIG. 9B a mechanical touch protection in the form of a cage structure 21 is provided in which, at least partially or regionally, a valve seat of the valve and a closing part (valve plate 11) of the valve that can be moved relative to the valve seat is received.

The cage structure 21 serves to protect the internal functional mechanics of the valve. Such protection is required when the valve is installed in the luggage compartment trough itself and, for example, needs to be protected against slipping loading.

While the present method and/or system has been described with reference to certain implementations, it will be understood by those skilled in the art that various changes may be made, and equivalents may be substituted without departing from the scope of the present method and/or system. In addition, many modifications may be made to adapt a particular situation or material to the teachings of the present disclosure without departing from its scope. For example, block and/or components of examples disclosed may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

### LIST OF REFERENCE NUMERALS

1 Vehicle
2 Luggage compartment/“frunk”
3 Luggage compartment cover/luggage compartment flap
10 Pressure relief valve/valve/valve assembly
11 Valve plate
12 Valve frame
13 Catching element
14 Sleeve-shaped element
15 Compression spring/spiral spring
16 Gasket
17 Clamping ring/clamping washer/lock washer
18 Countersunk grooved pin
19 Double-lip seal
20 Bolt/pin
21 Cage structure
100 Vehicle body component

What is claimed is:

1. A closing aid for a luggage compartment (2) that is configured in the front area of a vehicle (1) and can be hermetically sealed against the external atmosphere or at least substantially against the external atmosphere with the help of a luggage compartment cover (3) in the form of a luggage compartment flap, when the luggage compartment cover (3) is in its closed position, wherein the closing aid comprises a valve assembly (10), which is configured to become activated in the case of a sudden or abrupt increase in pressure in the volume defined by the luggage compartment (2) and the luggage compartment cover (3) in the closed position thereof, and to enable a pressure relief between the volume defined by the luggage compartment (2) and the luggage compartment cover (3) in the closed position thereof and the external atmosphere.

2. The closing aid according to claim 1,
wherein the valve assembly (10) is configured to become activated in the event of a pressure increase resulting from a deformation of the luggage compartment cover (3) and to enable a pressure relief between the volume defined by the luggage compartment (2) and the luggage compartment cover (3) in the closed position thereof and the external atmosphere.

3. The closing aid according to claim 1,
wherein a critical differential pressure value between the volume defined by the luggage compartment (2) and the luggage compartment cover (3) in the closed position thereof and the external atmosphere, at which the valve assembly (10) becomes activated, is defined or definable.

4. The closing aid according to claim 1,
wherein, in its open position, the luggage compartment cover (3) has a first rigidity value or a first collision energy absorption capacity and, in its closed position, has a second rigidity value or a second collision energy absorption capacity, wherein, due to an air volume at least substantially hermetically enclosed by the luggage compartment (2) and the luggage compartment cover (3) in the closed position thereof, the second rigidity value or the second collision energy absorption capacity is greater than the first rigidity value or the first collision energy absorption capacity.

5. The closing aid according to claim 4,
wherein the valve assembly (10) is configured such that, upon an activation of the valve assembly (10), due to the pressure relief caused thereby, the rigidity or collision energy absorption capacity of the luggage compartment cover (3) in its closed position decreases and takes on the first rigidity value or the first collision energy absorption capacity or takes on a rigidity value or a collision energy absorption capacity lying between the first and second rigidity values or between the first and second collision energy absorption capacities.

6. The closing aid according to claim 1,
wherein the valve assembly (10) is configured to weaken the structure and/or rigidity of the luggage compartment cover (3) upon activation thereof.

7. The closing aid according to claim 1,
wherein the valve assembly (10) comprises at least one valve, which is received and/or fixed in a receptacle opening in a wall delimiting the luggage compartment (2) and/or in the luggage compartment cover (3).

8. The closing aid according to claim 7,
wherein the at least one valve is configured such that it opens upon a defined or definable differential pressure between the volume defined by the luggage compartment (2) and the luggage compartment cover (3) in the closed position thereof and the external atmosphere.

9. The closing aid according to claim 7,
wherein the at least one valve of the valve assembly (10) comprises at least one check valve as an obturator.

10. The closing aid according to claim 7,
wherein the at least one valve of the valve assembly (10) is configured as a poppet valve or ball check valve; and/or
wherein the at least one valve of the valve assembly (10) is a weight-loaded, spring-loaded, rotary spring-loaded, and/or gravity-loaded valve.

11. The closing aid according to claim 7,
wherein the at least one valve of the valve assembly (10) comprises a cage structure (21), in which a valve seat of the valve and a closing part of the valve that is movable relative to the valve seat is at least partially or regionally received.

12. The closing aid according to claim 7,
wherein an activation behavior of the at least one valve of the valve assembly (10) is variably adjustable as a function of an air volume that is at least substantially hermetically enclosed by the luggage compartment (2) and the luggage compartment cover (3) in the closed position thereof.

13. The closing aid according to claim 7,
wherein the at least one valve of the valve assembly (10) is configured as a proportional valve, whose opening behavior moves in the range of an activation differential pressure up to full opening proportionately or at least substantially proportionately to the differential pressure between the volume defined by the luggage compartment (2) and the luggage compartment cover (3) in the closed position thereof and the external atmosphere, and/or wherein the at least one valve of the valve assembly (10) is configured as a full-stroke valve, which opens suddenly and with a full stroke upon activation.

14. The closing aid according to claim 1,
wherein the valve assembly (10) comprises a plurality of valves, each of which is received and/or fixed in a receptacle opening in a wall delimiting the luggage compartment (2) and/or in the luggage compartment cover (3).

15. A vehicle (1) comprising a luggage compartment (2) that is configured in the front region of the vehicle (1) and can be hermetically sealed at least partially against the external atmosphere or at least substantially against the external atmosphere with the help of a luggage compartment cover (3) in the form of a luggage compartment flap, when the luggage compartment cover (3) is in its closed position, wherein the vehicle (1) comprises a closing aid according to claim 1.
